(19) United States
(12) Patent Application Publication
(10) Pub. No.: US 2012/0286935 A1
(43) Pub. Date: Nov. 15, 2012

(54) UNPOWERED WIRELESS SENSOR SYSTEMS AND METHODS

(76) Inventor: Haiying HUANG, Arlington, TX (US)

(21) Appl. No.: 13/468,935

(22) Filed: May 10, 2012

Related U.S. Application Data
(60) Provisional application No. 61/484,285, filed on May 10, 2011.

(51) Int. Cl. G06K 7/01

(52) U.S. Cl. 340/10.1

(57) ABSTRACT

Devices, methods, and systems for wireless transmission of data from unpowered sensor nodes are presented. An unpowered sensor node includes a sensor, a first antenna for receiving an interrogation signal from a remote source, an up-converting frequency mixer, and a second antenna for transmitting a modulated output signal. A remote sensor interrogation unit generates and transmits the interrogation signal; then receives and demodulates the modulated output signal from the sensor nodes. Any type of sensor that generates an oscillatory signal can operate without a local power source. For a sensor that generates a non-oscillatory signal, the sensor node includes a low-power signal conditioning unit to convert the signal to an oscillatory signal. The sensor node may include an energy harvester such as a photocell to power the signal conditioning unit. A low-cost network of unpowered sensor nodes may be interrogated by a single interrogation unit using a multiplexing scheme.

### CROSS-REFERENCE TO RELATED APPLICATIONS

This application claims the benefit of and priority to U.S. Provisional Application No. 61/484,285 entitled “Unpowered Wireless Sensor System,” filed May 10, 2011, which is herein incorporated by reference in its entirety.

### BACKGROUND

The following disclosure relates generally to wireless systems for condition monitoring and damage detection.

Condition monitoring of systems and materials is a technology that can reduce maintenance costs, improve operation efficiency, and ensure safety. Damage detection based on ultrasonic waves is a popular and useful non-destructive inspection technique for monitoring materials and structures of all sizes, from machine components and medical devices to load-bearing structures such as buildings and bridges. Piezoelectric wafer transducers, for example, represent a compact, lightweight device for generating and sensing ultrasonic waves in materials. Ultrasound sensors are used in the aerospace industry, industrial plants, and manufacturing facilities. Because ultrasound-based sensors detect damage based on a propagating elastic wave, only a few sensors are required to monitor a relatively large area.

Wired sensors currently dominate the ultrasound sensor market, but they are expensive to install and maintain. Wiring adds a layer of complexity and cost. Wired sensors are impractical for large arrays and impossible in certain environments, such as rotating machine parts.

Wireless sensors typically require a robust onboard power source and do not have enough throughput to transmit high-frequency ultrasound signals that can have a frequency as high as several megahertz. Transmitting the full waveform is desirable because it contains much more information than a single measurement. Existing wireless sensor configurations are not capable of transmitting the full waveform of an ultrasound signal. For example, transmitting the full waveform of a 1 MHz ultrasound signal, sampled at 10 samples per cycle, with a 16-bit resolution would require a wireless sensor to transmit at a rate of 160 megabits per second. Current wireless sensors transmit data at a maximum rate of one megabit per second. Because of the limited data rate, existing wireless ultrasound sensor configurations process the data onboard and then transmit only the feature information. Onboard processing, however, consumes large amounts of power and is limited by the capability of the embedded microprocessor.

Condition monitoring and damage detection using strain gauges is also a popular and useful non-destructive inspection technique. Strain is a physical parameter that can be used to detect and measure material conditions such as deformation, load, boundary, pressure, vibration, and fatigue. Like ultrasound monitoring, strain measurement is a useful tool for monitoring materials and structures of all sizes. Traditionally, strains are measured using wired, thin-foil strain gauges, which offer a reliable, versatile, practical, and inexpensive solution. For larger machines and structures, however, distributing a large number of sensors across a wide area is important for gathering data about the entire structure's integrity. The burden of wiring a set of strain gauges imposes huge installation and maintenance costs.

Wireless strain gauges typically require a local power source, such as a battery. Because of the high power consumption of the wireless radio transceiver and the low energy density of batteries, powered wireless sensors can only be operated intermittently with a large duty cycle. Conventional thin-foil strain gauges are not suitable for unpowered wireless sensors because they require an excitation voltage and consume relatively high power.

The numerous limitations of existing wireless sensors are a serious limiting factor on the ability to install and maintain large networks of sensors to monitor and detect the condition of critical structures.

### SUMMARY

A wireless sensor system in various embodiments includes an unpowered sensor node and a remote signal generator. The sensor node includes: (1) a sensor that is in physical communication with an element under investigation in order to sense a condition of the element, wherein the sensor generates an input signal related to the condition; (2) a first antenna for receiving a first interrogation signal from a signal generator located remote from the sensor node; (3) an up-converting frequency mixer that is in communication with the sensor and configured to combine the input signal and the first interrogation signal and thereby generate a modulated output signal; and (4) a second antenna for transmitting the modulated output signal from the up-converting frequency mixer.

### BRIEF DESCRIPTION OF THE DRAWING

Having thus described various embodiments in general terms, reference will now be made to the accompanying drawings, which are not necessarily drawn to scale, and wherein:

FIG. 1 is a schematic illustration of a wireless sensor node, according to various embodiments.

FIG. 2 is a schematic illustration of a wireless sensor system that includes a sensor interrogation unit and the sensor node of FIG. 1.

FIG. 3 is a schematic illustration of a wireless sensor node that includes a sensor that generates a non-oscillatory signal and an energy harvester for collecting power, according to a second embodiment.

FIG. 4 is a schematic illustration of a wireless sensor system that includes a sensor interrogation unit and the sensor node of FIG. 3.

FIG. 5 is a circuit diagram of a sensing unit, according to various embodiments.

FIG. 6 is a circuit diagram of a photocell-based energy harvester, according to various embodiments.

FIG. 7 is a circuit diagram of a signal demodulator that includes a phase-locked loop circuit, according to various embodiments.

FIG. 8 is a schematic illustration of a wireless ultrasound generation system, according to various embodiments.

FIG. 9 is a schematic illustration of a wireless ultrasound inspection system, according to various embodiments.

FIG. 10 is a graphical representation of a multi-frequency excitation signal.

### DETAILED DESCRIPTION

The present systems and apparatuses and methods are understood more readily by reference to the following detailed description, examples, drawing, and claims, and their previous and following descriptions. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching in its best, currently known embodiment. To this end, those skilled in the relevant art will recognize and appreciate that many changes can be made to the various aspects described herein, while still obtaining the beneficial results of the technology disclosed. It will also be apparent that some of the desired benefits can be obtained by selecting some of the features while not utilizing others. Accordingly, those with ordinary skill in the art will recognize that many modifications and adaptations are possible, and may even be desirable in certain circumstances, and are a part of the invention described. Thus, the following description is provided as illustrative of the principles of the invention and not in limitation thereof.

As used throughout, the singular forms “a,” “an” and “the” include plural referents unless the context clearly dictates otherwise. Thus, for example, reference to “a” component can include two or more such components unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Wireless Sensor Systems

The following disclosure relates generally to wireless sensor systems for detecting the condition of an element under investigation, such as a machine component, pipeline, building, or bridge. According to various embodiments, a wireless sensor system includes one or more sensor nodes and a remotely located sensor interrogation unit (SIU). The SIU generates and transmits an interrogation signal to the sensor nodes, providing a carrier signal. Each sensor node includes a sensor, an up-converting frequency mixer, and one or more antennas—all on a small, lightweight, flexible substrate suitable for adhesive attachment to a variety of surfaces. The frequency mixer is configured to combine the input signal from the sensor with the carrier signal from the SIU and thereby generate a modulated output signal that is suitable for wireless transmission without digitization or compression. The data rate is several orders of magnitude higher than conventional wireless sensors. A large bandwidth of several megahertz can be achieved. In operation, a single SIU can be positioned near a network of sensor nodes, broadcasting the interrogation signal and receiving the modulated output signals from the sensor nodes for analysis.

According to a first embodiment, the sensor nodes include a sensor that generates an oscillatory signal. For example, a low-profile piezoelectric wafer sensor may be used to detect energy in various forms, including AE (acoustic emissions), vibration, and other phenomena, and then generate an oscillatory signal that is ready for processing by the up-converting frequency mixer. The sensor nodes require no battery or other local power source. The incoming interrogation signal from the SIU provides a carrier signal to accomplish the wireless transmission of the modulated output signal. The frequency mixer converts the ultrasound signal to a microwave signal and transmits it directly without digitization. Because the nodes require no electrical wiring and no power source, implementing a large number of sensor nodes becomes feasible.

According to a second embodiment, the sensor nodes include a sensor that generates a non-oscillatory direct current (DC) signal, such as a strain gauge. Non-oscillatory signals need to be converted before they are ready for processing by the up-converting frequency mixer. For example, a signal conditioning unit such as a Wheatstone bridge may be used with a strain gauge, along with a voltage-controlled oscillator, to convert the signal to an oscillating signal. Both the Wheatstone bridge and the voltage-controlled oscillator require an excitation voltage from a local power source. In this embodiment, the sensor node may include an energy harvester, such as a photocell, battery, or ambient RF energy collector, to provide a small amount of power (about 6 to 9 milliwatts, for example) for the conversion. Like in the first embodiment, the incoming interrogation signal from the SIU provides the carrier signal that drives the wireless transmission of the modulated output signal. Because these sensor nodes require no electrical wiring and an ultra-low power source, implementing a large number of sensor nodes is feasible.

### First Embodiment

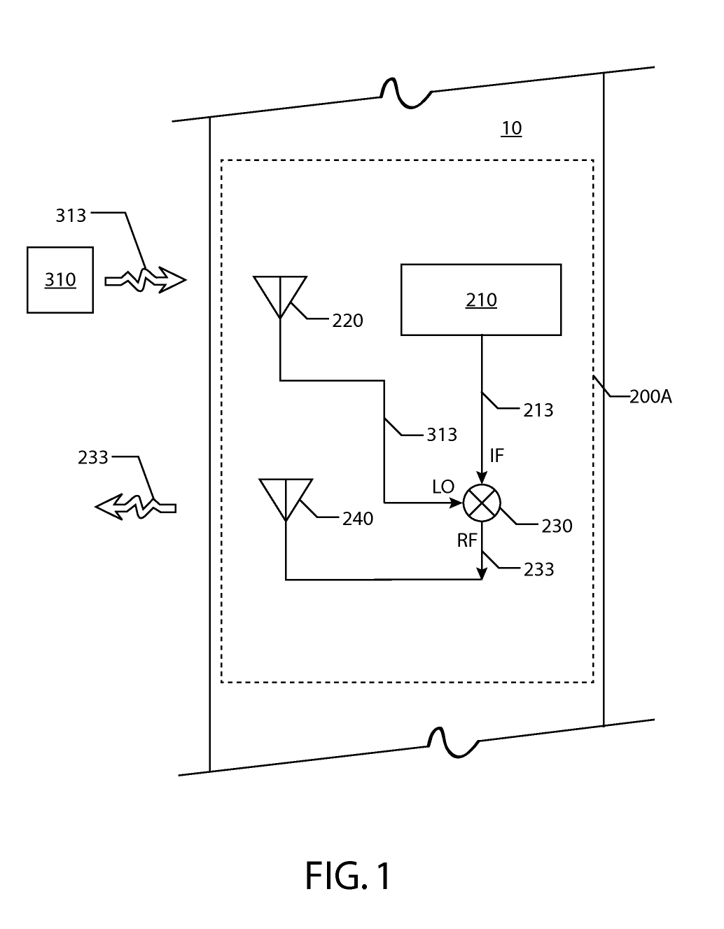

FIG. 1 is a schematic illustration of a wireless sensor node 200A according to a first embodiment. As shown, the sensor node 200A includes a sensor 210, a first antenna 220, an up-converting frequency mixer 230, and a second antenna 240. These discrete components are in communication with one another, as shown in FIG. 1. None of the components require any external power. All the components of the sensor node 200A may be located on a small, lightweight, flexible substrate that is suitable for adhesive attachment to a variety of surfaces.

The sensor 210 is in physical communication with an element 10 that is being monitored or is otherwise under investigation. The sensor 210 generates an input signal 213. The sensor 210, for example, may be a piezoelectric wafer sensor that detects energy such as AE (acoustic emissions) and generates an oscillatory signal 213. The sensor 210 detects the condition of the element 10 being monitored and generates an oscillatory signal 213 without any local power source.

The first antenna 220 is configured to receive a first interrogation signal 313 from a remote signal generator 310. The first antenna 220 also operates without any local power source.

The up-converting frequency mixer 230 is a nonlinear microwave device that converts a low-frequency signal to a high-frequency signal; a process also known as heterodyning. The mixer 230 has three ports; a local oscillator port (LO), an input port (IF), and an output port (RF). As shown, the mixer 230 receives the input signal 213 from the sensor 210 through the input port (IF) and combines it with the interrogation signal 313 through the local oscillator port (LO), thereby producing a modulated output signal 233 delivered through the output port (RF).

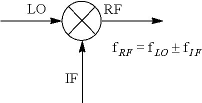

The mixer 230 operates without any local power source. In applications where the sensor 210 generates an oscillatory signal 213 in the ultrasound range, the mixer 230 operates to up-covert the ultrasound signal to a higher-frequency microwave signal that can be transmitted wirelessly using an antenna 240. The mixer 230 can be used to up-convert any oscillatory signal.

The second antenna 240 is configured to receive the modulated output signal 233 from the mixer 230 and then transmit it. The second antenna 240 operates without any local power source.

Antenna.

In one embodiment, a patch antenna may be used for the first antenna 220 and/or second antenna 240. A patch antenna, such as a rectangular microstrip antenna, is a type of radio antenna that has a low profile and can be mounted on a flat surface. The antenna includes a sheet or patch of metal mounted a precise distance above a slightly larger sheet of metal called a ground plane. The two metal sheets together form an electromagnetic resonator having a resonant frequency. A simple patch antenna radiates a linearly polarized wave.

In one embodiment, a single antenna can be designed with dual polarizations of the same resonant frequency. A single antenna can be used for both receiving and transmitting signals. For example, the incoming interrogation signal 313 can be received by the vertical polarization of a patch antenna. The modulated output signal 233 can be transmitted through the horizontal polarization of the same patch antenna. The patch antenna, for example, may be fabricating by attaching a Kapton film onto a metallic film, following by bonding a copper patch onto the Kapton film.

The sensor node in various embodiments may also include an impedance matching circuit. Because the piezoelectric wafer sensor 210 usually acts as a small capacitor, an impedance matching circuit may be designed in order to match the impedance of the sensor 210 and the 50-ohm impedance of the frequency mixer 230.

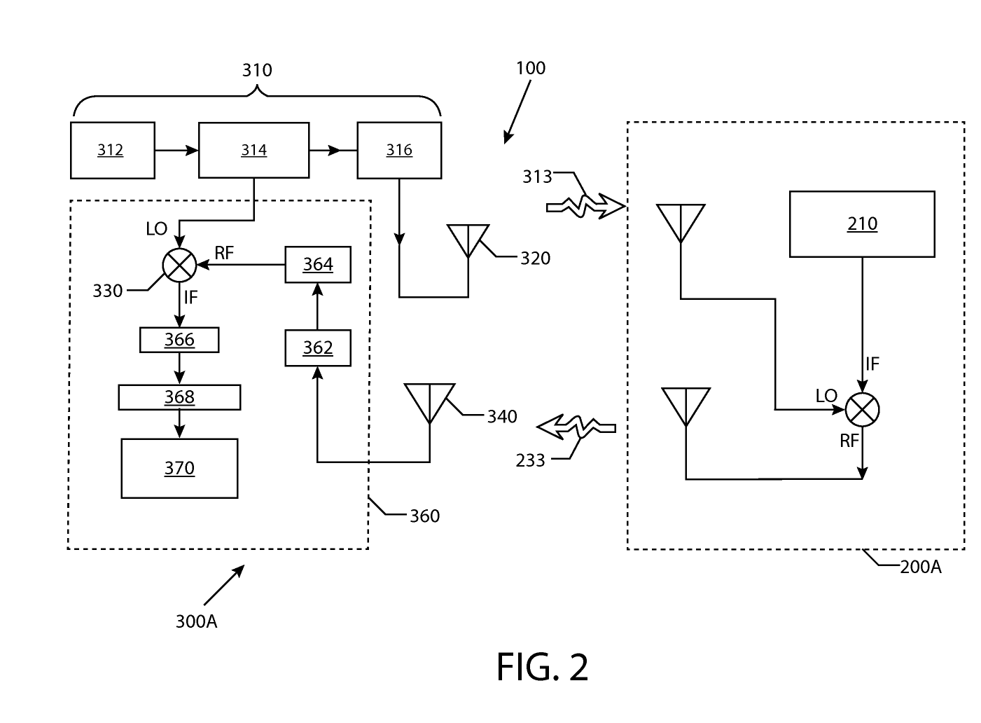

FIG. 2 is a schematic illustration of a wireless sensor system 100 that includes a sensor node 200A and a sensor interrogation unit 300A. As shown, the sensor interrogation unit (SIU) 300A includes a power source (not shown), a signal generator 310, a transmitting antenna 320, a receiving antenna 340, and a signal demodulator 360. These discrete components are in communication with one another, as shown in FIG. 2. All the components of the SIU 300A may be located on a small, lightweight, portable housing that is suitable for use in the field, either on a temporary or permanent basis.

The signal generator 310 is configured to generate a first interrogation signal 313 for broadcast by the transmitting antenna 320 and a LO signal for the down-converting mixer 330. In one embodiment, the signal generator 310 includes a radio frequency source 312, a directional coupler 314, and a power amplifier 316. The directional coupler 314 may act as a signal splitter; one part of the signal serves as the LO signal for the down-converting frequency mixer 330, and the other part of the signal serves as the interrogation signal 313 to be amplified by the amplifier 316 and then broadcast by the transmitting antenna 320 to the sensor node 200A.

The transmitting antenna 320 may be an antenna that is configured to broadcast the interrogation signal 313 to the sensor node 200A.

The receiving antenna 340 may be an antenna that is configured to receive the modulated output signal 233 from the sensor node 200A.

The signal demodulator 360 in one embodiment includes a number of filters and amplifiers, along with a down-converting frequency mixer 330. The down-converting frequency mixer 330 receives the modulated output signal 233 through the RF port and combines it with the LO signal from the directional coupler 314 in order to produce a signal through the IF port that is equivalent to the input signal 213 generated by the sensor 210 on the sensor node 200A.

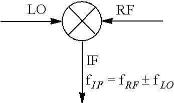

In this aspect, the mixer down-coverts the microwave signal back to its original ultrasound frequency.

The signal demodulator 360 in one embodiment includes a band pass filter 362 and a low-noise amplifier 364 for amplifying the signal. After the down-converting frequency mixer 330, the signal from the IF port may be filtered by a low pass filter 366 in order to obtain a signal that is equivalent to the original input signal 213 generated by the sensor 210. After filtering, the ultrasound input signal 213 may be amplified again using a pre-amplifier 368, as shown, and acquired using a data acquisition unit 370.

Power Transmission:

The sensor node in various embodiments does not require a battery or other local power source. Instead, the sensor node via the frequency mixer 230 produces the modulated output signal 233 by modulate the interrogation signal 313 using the sensor signal 213.

Assuming the first antenna 220 on the sensor node is located at a distance d from the transmitting antenna 320, the power Ps of the signal received by the first antenna 220 can be calculated as

$${P}_{s} = \frac{{P}_{i} {G}_{h} {G}_{s} {λ}^{2}}{{( 4 π d )}^{2}} ,$$

where Pi is the interrogation power, Gh is the gain of the transmitting antenna 320, Gs is the gain of the first antenna 220, and λ is the microwave wavelength. Denoting the root-mean-square (RMS) amplitude of the output of the wired piezoelectric wafer sensor 210 as V_{U}, the RMS amplitude of the ultrasound-modulated signal is

$${V}_{m} = {V}_{r} {V}_{U} = \sqrt{{P}_{s} R} {V}_{U} = \sqrt{{P}_{i} {G}_{h} {G}_{s} R} \frac{λ}{4 π d} {V}_{U} ,$$

where R is the impedance of the up-converting frequency mixer 230 on the sensor node. The power of the ultrasound-modulated signal, taking the insertion loss Amixer1 of the mixer 230 into consideration, is

$${P}_{m} = {A}_{mixer 1} ( \frac{{V}_{m}^{2}}{R} ) = \frac{{A}_{mixer 1} {P}_{i} {G}_{h} {G}_{s} {λ}^{2}}{{( 4 π d )}^{2}} {V}_{U}^{2} .$$

The power Pr of the modulated signal received by the receiving antenna 340 on the SIU can be calculated as

$${P}_{r} = \frac{{P}_{m} {G}_{h} {G}_{s} {λ}^{2}}{{( 4 π d )}^{2}} = \frac{{A}_{mixer 1} {{P}_{i} ( {G}_{h} {G}_{s} )}^{2} {λ}^{4}}{{( 4 π d )}^{4}} {V}_{U}^{2} .$$

Denoting the gain of the low-noise amplifier 364 is A_{LNA} and the gain of the pre-amplifier 368 as Aamp, the RMS amplitude of the recovered ultrasound signal is

$$\begin{matrix}{V}_{RU} = \sqrt{{A}_{amp} {P}_{IF} R} \\ = \sqrt{{A}_{amp} {A}_{LNA} {A}_{mixer 1} {A}_{mixer 2} {P}_{i} {P}_{LO}} \frac{{G}_{h} {G}_{s} {λ}^{2}}{{( 4 π d )}^{2}} {RV}_{U} ,\end{matrix}$$

where Amixer2 is the insertion loss of the down-converting frequency mixer 330 and P_{LO} is the power of the LO signal.

### Second Embodiment

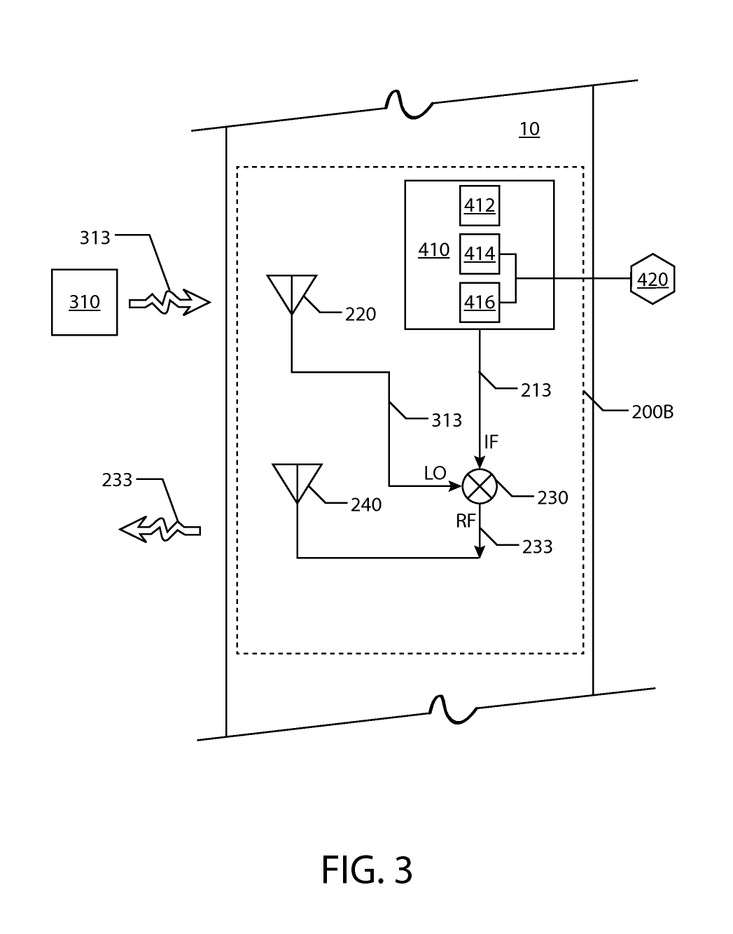

FIG. 3 is a schematic illustration of a wireless sensor node 200B that includes a sensor 412 that generates a non-oscillatory signal and an energy harvester 420 for collecting power, according to a second embodiment. As shown, the sensor 410 may include a strain gauge 412, a signal conditioning unit 414 and a voltage-controlled oscillator 416 for converting the non-oscillatory (DC) signal from the strain gauge into an oscillatory signal 213. The signal 213 would then enter the input port IF of the up-converting frequency mixer 230.

Both the signal conditioning unit 414 and the voltage-controlled oscillator 416 require an excitation voltage from a local power source in order to convert the DC signal to an oscillatory signal. In this embodiment, the sensor node may include an energy harvester 420, such as a photocell, battery, or ambient RF energy collector, to provide a small amount of power (about 6 to 9 milliwatts, for example) for the conversion.

The wireless sensor node 200B, as shown in FIG. 3, includes a sensing unit 410, an energy harvester 420, and an unpowered wireless transponder such as the second antenna 240. As shown, the sensing unit 410 may include a strain gauge 412 or any other type of sensor that produces a non-oscillatory signal. The strain gauge 412 may be a conventional thin-foil strain gauge attached to the surface of a material or, in one embodiment, a carbon nanotube thread (CNT) sensor that may be embedded or otherwise integrated into a polymeric or composite material.

In one embodiment, the strain is measured using a conventional foil strain gauge 412 and a Wheatstone bridge 414, which produces a direct-current (DC) signal (assuming the structure or element 10 is under a static load). In order to transmit this DC signal using the unpowered wireless system, the DC strain signal is converted to an oscillatory signal using a voltage-controlled oscillator (VCO) 416. The oscillatory signal 213, whose frequency is proportional to the DC signal, is up-converted by the frequency mixer 230 to microwave frequency and using the unpowered wireless transponder/second antenna 240, is transmitted wirelessly and recovered by the SIU 300.

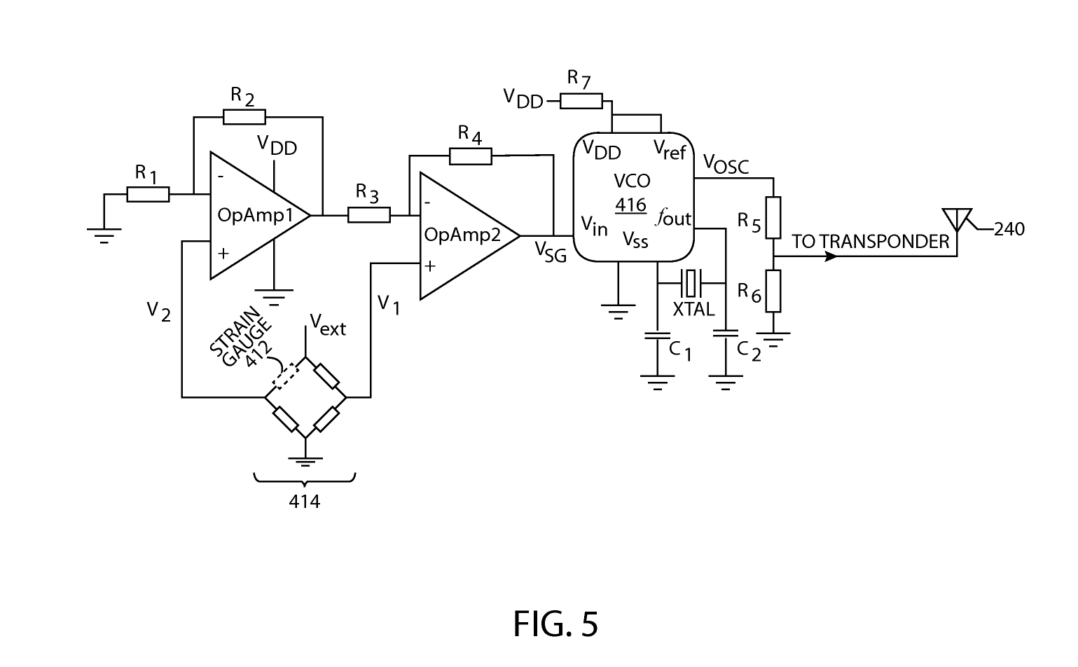

The circuit diagram of the sensing unit 410 in one embodiment is shown in FIG. 5. For example, a 1 kΩ strain gauge 412 may be implemented as one arm of a quarter-bridge Wheatstone bridge completion module 414 that converts the strain gauge resistance change into a differential voltage output. This differential output of the Wheatstone bridge, i.e. V₁ and V₂, is then amplified and converted to a single-end signal V_{SG} using two operational amplifiers OpAmp 1 and OpAmp2. The gain of the difference amplifier circuit is determined by the two resistors R₁ and R₂, assuming the resistors R₃=R₂ and R₄=R₁, i.e.

$${G}_{amp} = \frac{{V}_{SG}}{{V}_{1} - {V}_{2}} = 1 + \frac{{R}_{2}}{{R}_{1}} . \qquad ( 1 )$$

A selection of R₁=3.3 kΩ and R₂=330 kΩ therefore results in a gain of 101. The output of the difference amplifier is fed to the VCO 416 to generate an oscillatory signal V_{osc} whose frequency fₒᵤₜ is proportional to the amplifier output V_{SG} as

$${f}_{out} = 0.8 \times {f}_{clk} \times \frac{{V}_{SG}}{{V}_{ref}} + 0.1 \times {f}_{clk} , \qquad ( 2 )$$

where f_{clk} is the clock frequency provided by a crystal oscillator XTAL and V_{ref} is the reference voltage. Thus, for an input voltage V_{SG} ranging from zero volts to V_{ref} and a clock frequency of 1 MHz, the fₒᵤₜ frequency varies from 100 kHz to 900 kHz. The amplitude of the VCO output signal is 2.1 V. To prevent saturating the frequency mixer of the unpowered wireless transponder, this amplitude is reduced using a voltage divider. A combination of R₅=575Ω and R₆=50Ω reduces the VCO output signal to around 300 mV, which is then supplied to the unpowered wireless transponder. Based on the principle of foil strain gauges, the strain c can be calculated as

$$ɛ = \frac{4}{GF} \frac{{V}_{1} - {V}_{2}}{{V}_{ext}} , \qquad ( 3 )$$

where Vₑₓₜ is the excitation voltage of the Wheatstone bridge 414 and GF is the gauge factor. Combining equation (1), (2), and (3) gives the relationship between the measured strain ε and the frequency of the oscillatory signal fₒᵤₜ as

$$ɛ = \frac{( {f}_{out} - 0.1 \times {f}_{clk} ) \times {V}_{ref}}{0.8 \times {f}_{clk} \times {G}_{amp} \times {V}_{ext} \times ( GF / 4 )} . \qquad ( 4 )$$

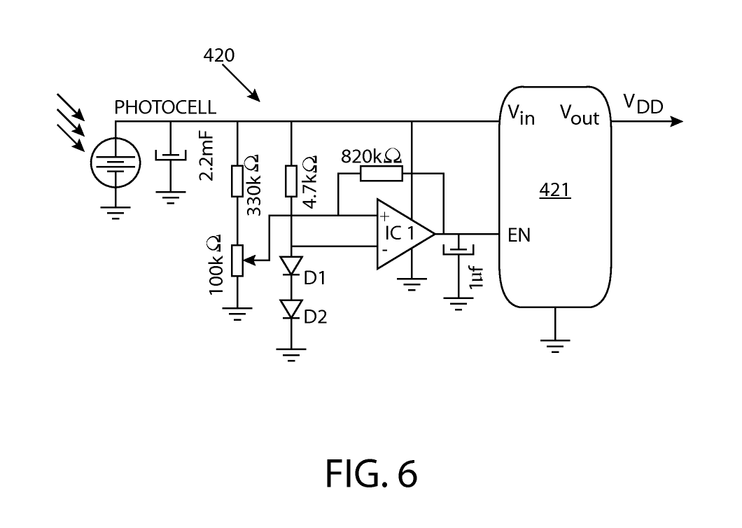

The VCO 416 requires a supply voltage of 2.7 V and consumes around 3 mW when operating continuously. This required power can be supplied from an energy harvester 420 such as a photocell. A circuit diagram for an exemplary photocell is shown in FIG. 6. The output voltage of a photocell depends on the optical power incident on the photocell and the load resistance connected to it. Optical power fluctuation can therefore change the voltage across the load. In order to maintain a constant voltage, a voltage booster may be used. For example, a microchip-based voltage booster can convert an input voltage as low as 0.65 V up to 3.4 V. In order to address the high in-rush current required by the voltage booster at the start-up phase, a 2.2 mF capacitor may be placed across the photocell, as shown in FIG. 6. This capacitor decreases the effective source impedance of the photocell while supplying the in-rush current required to startup the boost converters. A Schmitt trigger voltage comparator circuit may be introduced to delay the startup of the boost converter until the capacitor acquires enough charge. The Schmitt trigger voltage comparator circuit was designed to keep the Enable pin of the microchip-based voltage booster low, unless the input voltage to the booster exceeds a preset value, set by the 100 kΩ potentiometer. At the beginning, when the photocell is first exposed to the light, the voltage across the capacitor is low. Thus the boost converter is turned off by the comparator circuit. Continued exposure of the photocell to light increases the voltage of the capacitor. Once it reaches a preset voltage value of 3.137 V, in this example, the comparator turns on the boost converter. The energy stored in the capacitor is sufficient to supply the high in-rush current required by the boost converter. After passing the startup stage, the boost converter does not require much power (about 1 mW) to sustain its operation. The system operates continuously as long as the photocell and the light source are selected properly. In case the light source is removed, the voltage across the capacitor will drop below the threshold after a period of discharge. The comparator circuit will then turn off the boost converter and keep it on standby, waiting for the next exposure of light.

In one embodiment, the power provided by the energy harvester 420 should be sufficient to support the continuous operation of the voltage booster as well as the sensing unit 410. According to Ohm's law, the power consumption of the Wheatstone bridge 414 is determined by the excitation voltage Vₑₜ and the resistance of the strain gauge R, i.e.

$$P = \frac{{V}_{ext}^{2}}{R} . \qquad ( 5 )$$

Therefore, a 1 kΩ strain gauge may be chosen instead of a more conventional size, such as 350Ω. In addition, a voltage divider may be introduced in order to produce an excitation voltage of 1.04 V for the Wheatstone bridge 414, by installing a 2.7 kΩ resistor in series with the Wheatstone bridge 414. With this arrangement, the total power consumption of the Wheatstone bridge 414 and the 2.7 kΩ resistor is estimated to be 3.33 mW. In addition, it was observed that the VCO 416 drew too much current if it was directly connected to the output of the voltage booster. A 1 kΩ resistor may be installed between the voltage booster and the VCO 416. The resistor (R₇ in FIG. 5) reduces the current drawing from the power supply, which ensures the continuous operation of the VCO 416. In one embodiment, the size of the solar panel is 60 mm square.

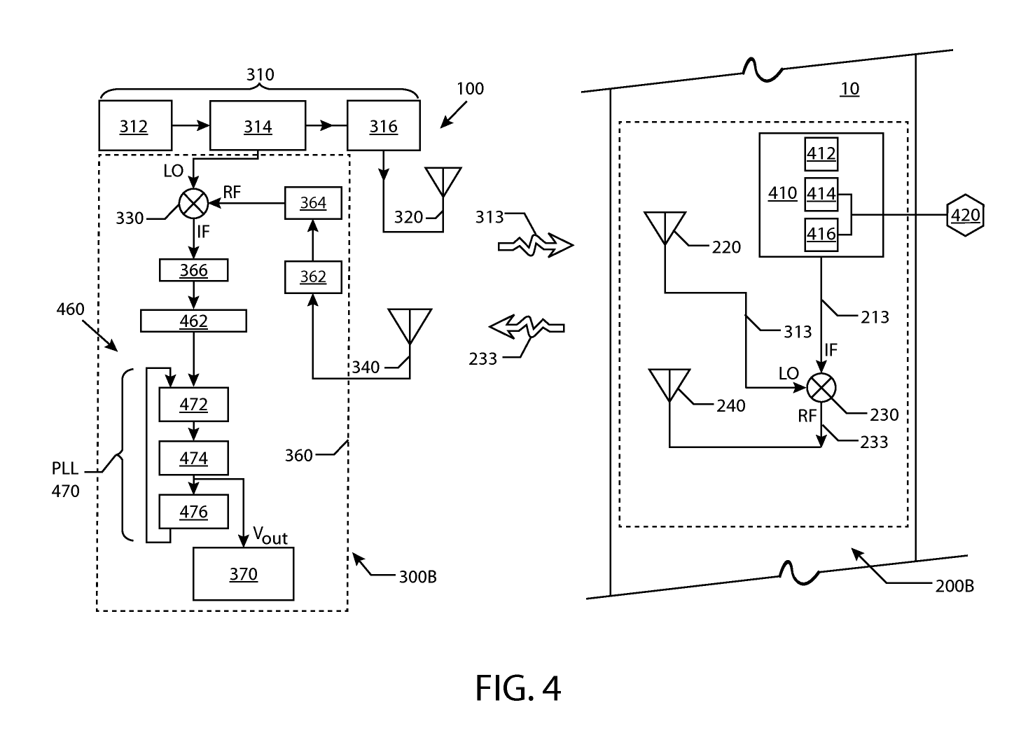

FIG. 4 is a schematic illustration of a wireless sensor system 100, according to a second embodiment, that includes a sensor node 200B and a sensor interrogation unit 300B. As shown, the sensor interrogation unit (SIU) 300B includes a power source (not shown), a signal generator 310, a transmitting antenna 320, a receiving antenna 340, and a signal demodulator 360. The signal generator 310 is configured to generate a first interrogation signal 313 for broadcast by the transmitting antenna 320 to the sensor node 200B.

In this second embodiment, the signal demodulator 360, as shown, may include a demodulation node 460. The demodulation node 460 in one embodiment may include an amplifier 462 and a Phase-Locked Loop (PLL) circuit 470. The PLL circuit 470 may include a phase comparator 472, an external low pass filter 474, and a voltage-controlled oscillator 476. These components are in communication with one another, as shown in FIG. 4. All the components of the SIU 300B may located on a small, lightweight, portable housing that is suitable for use in the field, either on a temporary or permanent basis.

The PLL circuit 470 tracks the frequency of the modulated output signal 233 received from the sensor node 200B and demodulates it into the original DC sensor signal 413. In one embodiment, the modulated output signal 233 may have a frequency of between 100 and 160 kHz. Data acquisition (using DAQ unit 370) of such high-frequency signals requires high sampling rate and thus consumes a lot of power. The demodulation node 460 at the SIU 300B may be used to simplify the data collection process.

The PLL circuit 470 is capable of locking the phase of the VCO output to the phase of the input signal within a certain frequency range, by adjusting the control voltage of the VCO 476 internally. For example, if the input signal is the frequency-modulated output signal 233, then the control voltage of the VCO 476 therefore reveals the frequency of the modulated output signal 233 and thus the original strain information can be deduced from the VCO control voltage.

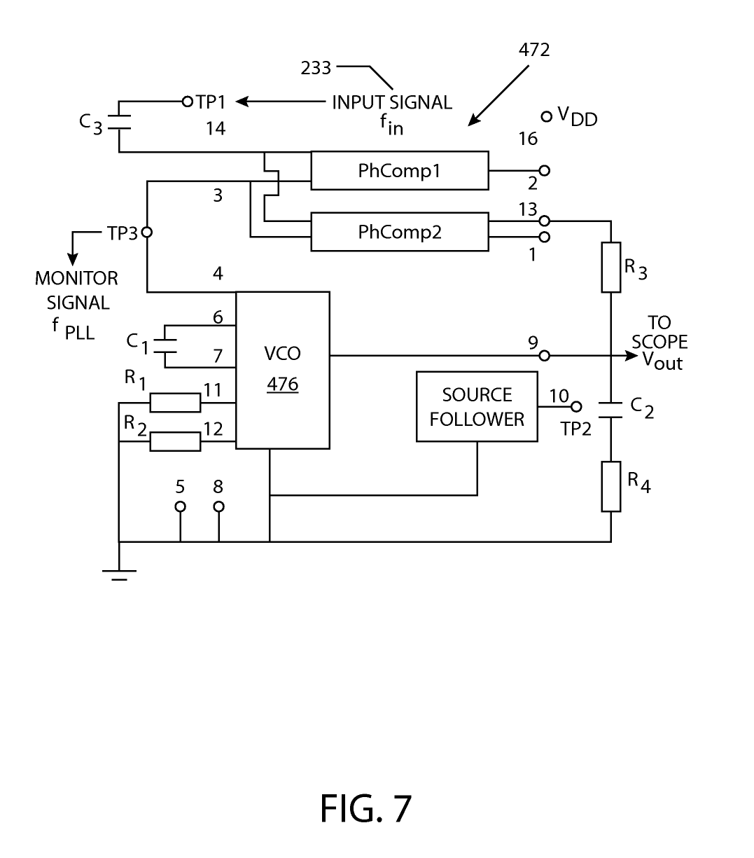

The circuit diagram of the demodulation node 460 in one embodiment is shown in FIG. 7. A PLL circuit 470 may be used as the core structure of the demodulation node 460. The strain modulated oscillatory signal fᵢₙ, which is directly from the VCO output of the strain sensor node 200B, will serve as the input at the PLL TP1 pin. Capacitor C3 is set to 0.1 uF for the input coupling. There are two phase comparators on the PLL chip, i.e. PhComp 1 and PhComp 2. Only PhComp 2 will be used as the phase comparator between the fᵢₙ and the feedback signal f_{PLL} from VCO 476 in the PLL 470. As long as a difference between the phases of the input and feedback signals exists, the phase comparator 472 will continue to adjust the PLL VCO control voltage Vₒᵤₜ at Pin 9, which can be measured by an oscilloscope.

In one embodiment, a low pass loop filter (LPLF) 474 may be implemented at the output of the phase comparator 472. The LPLF 474 is designed to remove the ripple and high frequency noises, and thus produce a near-DC control voltage at the VCO control voltage input at Pin 9. The loop filter 474 may be constructed by the relation between resistors R₃ and R₄ with capacitor C₂ as

$$\begin{matrix}\frac{6}{{f}_{max}} - \frac{1}{2 π ( Δ f )} = {R}_{4} \times {C}_{2} , & ( 2 ) \\ ( {R}_{3} + 3000 ) \times {C}_{2} = \frac{100 ( Δ f )}{{f}_{max}^{2}} , & ( 3 )\end{matrix}$$

where Δf=fₘₐₓ−fₘᵢₙ in which fmax and fmin defines the hold range of the PLL 470. Allowing the strains to vary between 0 to 3000 micro-strains, fmin and fmax may be selected to be 100 kHz and be 160 kHz, respectively. The R₃ and R₄ values may be then calculated from equations (2) and (3) as 205 kΩ and 35 kΩ C₂ may be set to be 1 nF, and it may be placed as close to the chip as possible for the stability issue. With C₁=0.1 nF, the values may be obtained for R₁=120 kΩ and R₂=76 kΩ from equation (4).

$$\begin{matrix}{f}_{max} = \frac{1}{{R}_{1} ( {C}_{1} + 32 pF )} + {f}_{min} \\ = \frac{1}{{R}_{1} ( {C}_{1} + 32 pF )} + \frac{1}{{R}_{2} ( {C}_{1} + 32 pF )} .\end{matrix} \qquad ( 4 )$$

The VCO 476 may generate a square wave signal f_{PLL} at TP3. This signal and the voltage Vₒᵤₜ at Pin 9 is related by a linear equation:

f_{PLL}=k_{vco}×Vₒᵤₜ. (5)

where k_{VCO} is a constant that can be measured experimentally.

When the input signal fᵢₙ and the output of the VCO f_{PLL} are in phase—in other words, the two signals are locked—the frequencies of the two signals are the same:

fᵢₙ=f_{PLL}. (6)

The strain signal can thus be demodulated from the DC signal Vₒᵤₜ. The relationship between the measured strain □ and the frequency of the oscillatory signal fₒᵤₜ is

$$ɛ = \frac{( {f}_{out} - 0.1 \times {f}_{clk} ) \times {V}_{ref}}{0.8 \times {f}_{clk} \times {G}_{amp} \times {V}_{ext} \times ( GF / 4 )} \qquad ( 7 )$$

where Vₑₓₜ is the excitation voltage of the Wheatstone bridge 414, and V_{ref} is the reference voltage of the VCO 416 on the sensor node 200B. The clock frequency f_{clk} of the strain sensor VCO 416 is 1 MHz, the signal amplifier gain Gₐₘₚ is 101, and the gauge factor GF is 2.0. Substituting equations (5) and (6) into (7) gives the relationship between the strain measurement and the PLL control voltage Vₒᵤₜ as

$$ɛ = \frac{( {k}_{vco} \times {V}_{out} - 0.1 \times {f}_{clk} ) \times {V}_{ref}}{0.8 \times {f}_{clk} \times {G}_{amp} \times {V}_{ext} \times ( GF / 4 )} . \qquad ( 8 )$$

In the context of a strain sensor on a beam under a static load, the strain experienced by the beam at a specific load P is calculated according to the flexure formula, i.e.

$${ɛ}_{estimate} = \frac{σ}{E} = \frac{6 Px}{{h}^{2} bE} , \qquad ( 9 )$$

where x is the distance between the load-applying point and the location of the strain gauge 412, h is the height of the beam, b is the width of the beam, and E is the Young's modulus of the beam material.

Wireless Generation and Steering of Ultrasound

Based on the principle of frequency conversion, described herein, a low frequency signal, e.g. an ultrasound signal, can be converted to a high frequency signal, e.g. a microwave signal, and vice versa. Converting an ultrasound signal to a microwave signal allows it to be transmitted wirelessly.

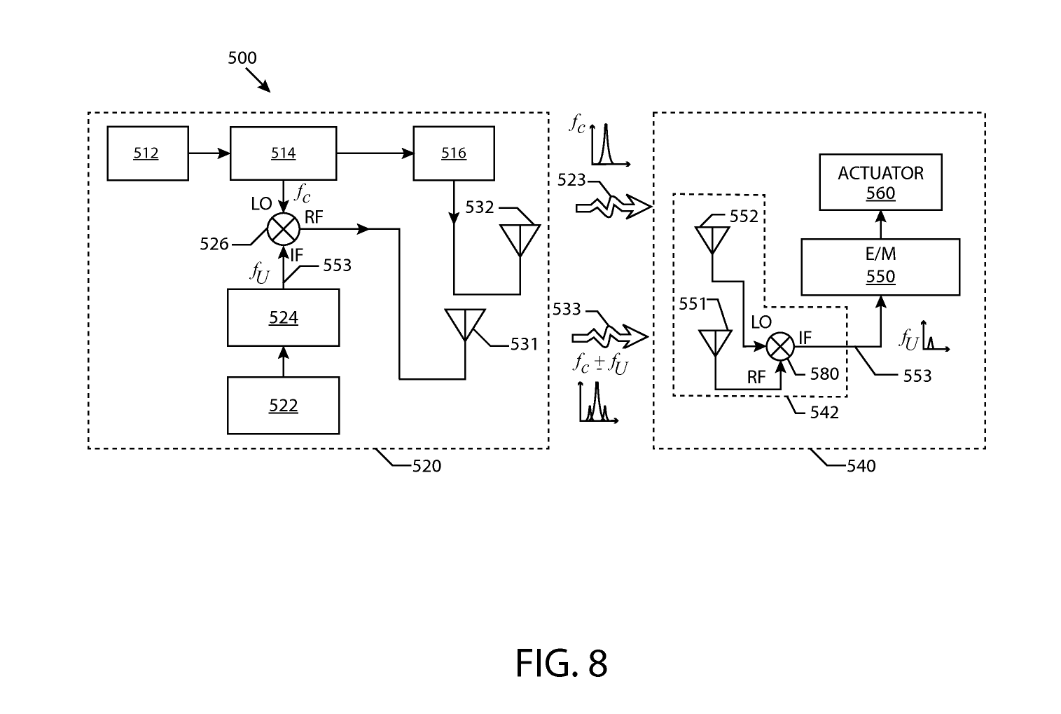

FIG. 8 is an illustration of a wireless ultrasound generation system 500. In one embodiment, the system 500 includes a wireless ultrasound transmitter 520 and an unpowered wireless ultrasound actuator 540. The wireless ultrasound actuator 540, as shown, includes a microwave receiver 542, an electrical impedance matching (EIM) network 550, and an actuator 560 (for example, a piezoelectric wafer actuator). The EIM network 550 may be introduced to match the electrical impedance of the microwave receiver 542 and the actuator 560.

The wireless ultrasound transmitter 520 in one embodiment, includes a RF source 512, a directional coupler 514, and a power amplifier 516 that is connected to a second transmitting antenna 532. The transmitter 520, as shown, also includes a signal generator 522, a signal amplifier 524, and an up-converting frequency mixer 526. The output RF of the frequency mixer 526 is connected to a first transmitting antenna 531. The transmitter 520 generates and transmits two signals: (1) a carrier signal 523 (f_{c}) sent by the second transmitting antenna 532 and (2) an ultrasound-modulated signal 533 (f_{c}±fᵤ) sent by the first antenna 531.

The wireless ultrasound actuator 540 includes a first receiving antenna 551 and a second receiving antenna 552. The microwave receiver 542 receives the two signals 523, 533 from the transmitter 520 and recovers the ultrasound signal 553 (fᵤ) using a down-converting frequency mixer 580.

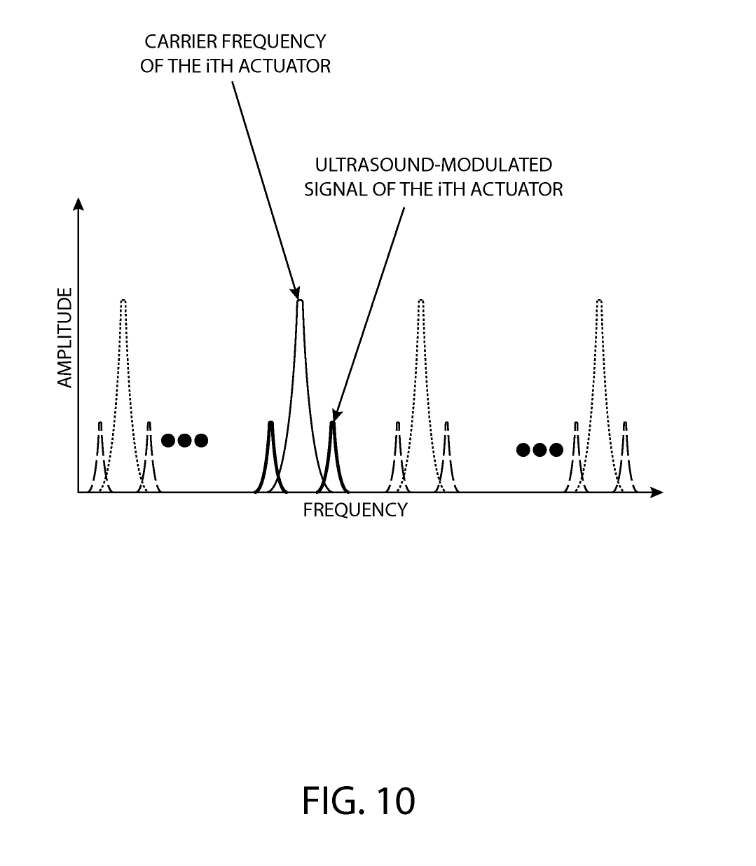

Steering of the ultrasound can be achieved using a phased array by exciting each wireless ultrasound actuator (540a, 540b, 540c, etc.) consecutively, with a time delay. This technique requires the unique identification and selective excitation of each individual actuator. The wireless ultrasound actuator 540 can be differentiated if the microwave receiver (542a, 542b, 542c, etc.) on each actuator (540a, 540b, 540c, etc.) is operated at a different frequency. By designing the microwave receiver to have a narrow bandwidth, it will only respond to the excitation signal whose frequency matches with its operation frequency. To excite a transducer array, for example, a multi-frequency excitation signal may be broadcast to the array, as illustrated graphically in FIG. 10. The carrier signal at a particular frequency will be modulated using the ultrasound signal with a given time delay. This carrier frequency will match the operation frequency of a specific actuator. Therefore, each actuator will receive the ultrasound signal at a different time. By adjusting the time delays, steering of the ultrasound beam using an array of wireless ultraosound actuators (540a, 540b, 540c, etc.) can be achieved.

Wireless Ultrasound Inspection System

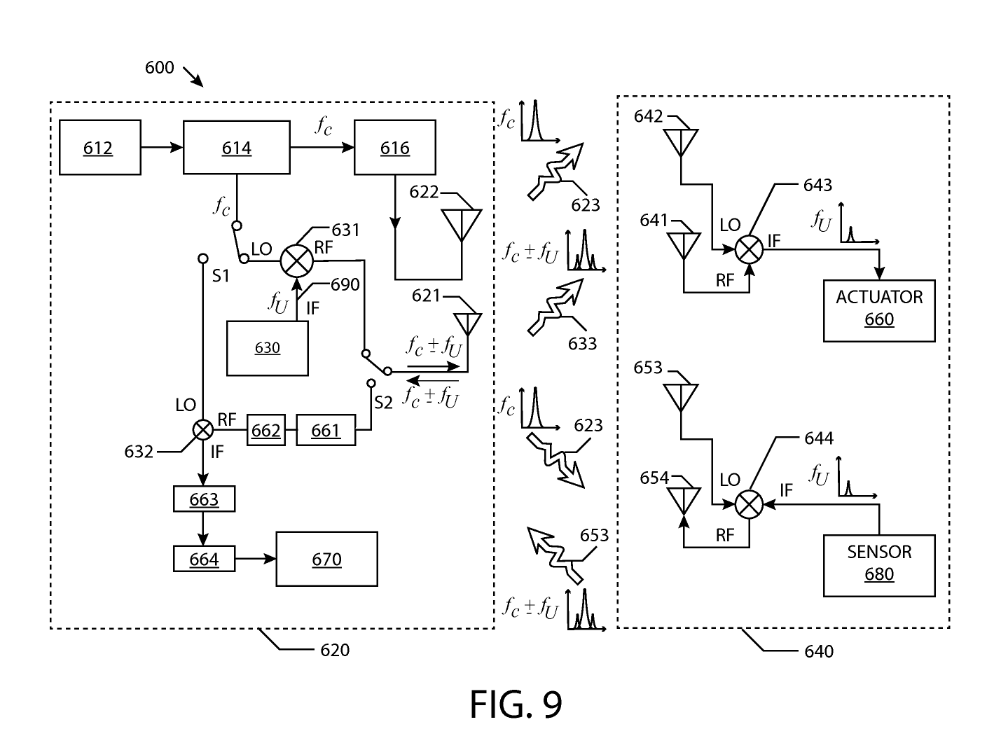

The principle of frequency conversion described herein can be applied to a wireless ultrasound inspection system 600, as shown in FIG. 9. The system 600 may include a wireless interrogator 620 and a wireless node 640.

In this application, the wireless node 640 may include both an actuator 660 and a sensor 680. A signal transmitted to the node 640 excites the actuator 660, which produces energy that passes through the material. The energy travels through the material until it reaches the sensor 680, which then transmits the resulting signal back to the wireless interrogator 620. For example, the actuator 660 may be a piezoelectric wafer actuator that generates a wave in the ultrasound range, which travels through the material. The sensor 680 may be a piezoelectric wafer sensor that is configured to receive the ultrasound wave and then transmit a signal back to the wireless interrogator 620. Analysis of the data reveals information about the condition of the material.

The wireless interrogator 620, as shown, includes a RF source 612, a directional coupler 614, a power amplifier 616, and a second transmitting antenna 622. The wireless interrogator 620 also includes a signal generator 630, a first frequency mixer 631, and a second frequency mixer 632. The signal generator 630 generates an ultrasound signal 690 (f_{U}).

For wireless ultrasound generation, the wireless interrogator 620 first generates the ultrasound modulated signal by placing the two switches S1, S2, in the positions shown in FIG. 9 (i.e., position P1). The output of the directional coupler 614 is supplied to the LO port of the first frequency mixer 631 (Mixer 1) while an ultrasound signal generated by a signal generator 630 is supplied to the IF port of the first frequency mixer 631. As a result, the first mixer 631 produces an ultrasound modulated signal 633 that can be wirelessly transmitted through a first transmitting antenna 621. At the same time, a carrier signal 623 is transmitted by the second transmitting antenna 622.

These two signals 633, 623 are received by the first receiving antenna 641 and the second receiving antenna 642 of the wireless node 640 supplied to a third frequency mixer 643 in order to recover the ultrasound signal 690 (f_{U}). The carrier signal 623 is also received by a third receiving antenna 653 on the wireless node 640. The carrier signal 623 is used by the fourth mixer 644. The recovered ultrasound signal 690 (f_{U}) is then supplied to the actuator 660 (e.g., the piezoelectric wafer actuator) in order to generate an ultrasound wave propagating in the material to be inspected or monitored.

After a short delay, the ultrasound wave will reach the sensor 680 (e.g., the piezoelectric wafer sensor). The oscillatory electrical signal generated by the piezo wafer sensor 680 is then supplied to the IF port of a fourth frequency mixer 644 for up-converting.

At the wireless interrogator 620, after sending the ultrasound modulated signal 633, the two switches S1, S2 will be switched to position P2. This setting with set the first antenna 621 to receive the ultrasound modulated signal 653 transmitted by fourth antenna 654 on the wireless node 640. Because the output of the directional coupler is connected to the LO port of the second mixer 632 for down-converting, the demodulation of the received ultrasound-modulated signal 653 remains the same as described above. For example, the wireless interrogator 620 may include a first band pass filter 661, a low noise amplifier 662, a second band pass filter 663, a pre-amplifier 664, and a data acquisition unit 670.

In this aspect, the frequency mixer technology described herein can be applied to configure a wireless ultrasound inspection system 600, which in one embodiment, includes a wireless interrogator 620 and a wireless node 640 having both an actuator 660 and a sensor 680.

### CONCLUSION

Although the systems are described herein in the context of non-destructive condition monitoring and damage detection, the technology disclosed herein is also useful and applicable in other contexts. Moreover, although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims. Moreover, although specific terms are occasionally used herein, as well as in the claims or concepts that follow, such terms are used in a generic and descriptive sense only, and should not be construed as limiting the described invention or the claims that follow.

1. A wireless sensor system comprising an unpowered sensor node and a remote signal generator, said sensor node comprising:
a sensor in physical communication with an element under investigation in order to sense a condition of said element, wherein said sensor generates an input signal related to said condition;
a first antenna for receiving a first interrogation signal from a signal generator located remote from said sensor node;
an up-converting frequency mixer that is in communication with said sensor and configured to combine said input signal and said first interrogation signal and thereby generate a modulated output signal; and
a second antenna for transmitting said modulated output signal from said up-converting frequency mixer.

2. The wireless sensor system of claim 1, further comprising a sensor interrogation unit located remote from said sensor node, wherein said sensor interrogation unit comprises:
said signal generator configured to generate said first interrogation signal;
a transmitter for transmitting said first interrogation signal from said signal generator;
a receiver for receiving said modulated output signal from said sensor node; and
a signal demodulator configured to recover said input signal from said modulated output signal.

3. The wireless sensor system of claim 2, wherein said signal demodulator comprises:
a down-converting frequency mixer in communication with said receiver and configured to combine said output signal and said first interrogation signal and thereby recover said input signal representative of said condition of said element.

4. The wireless sensor system of claim 2, wherein said signal generator comprises:
a radio source for generating an RF signal;
a directional coupler configured to generate a signal having a frequency that is substantially equivalent to the frequency of said first interrogation signal; and
a power amplifier configured to amplify said first interrogation signal for broadcast by said transmitter.

5. The wireless sensor system of claim 1, wherein said sensor node further comprises an impedance matching circuit configured to match the impedance of the sensor 210 and the impedance of the frequency mixer 230.

6. The wireless sensor system of claim 1, wherein said first antenna comprises a vertical polarization on a patch antenna having dual polarizations of the same resonant frequency, and wherein said second antenna comprises a horizontal polarization on said patch antenna.

7. The wireless sensor system of claim 1, wherein said input signal from said sensor has a frequency in the ultrasound range, and wherein said modulated output signal has a frequency in the microwave range.
